(19) United States
(12) Patent Application Publication
(10) Pub. No.: US 2010/0089341 A1
(43) Pub. Date: Apr. 15, 2010

(54) Hydrogen Reactor and Injection System for Augmenting Crankcase Ventilation in an Internal Combustion Engine

(76) Inventors: James Richardson, Helendale, CA (US); James A. Chadick, La Mirada, CA (US); Harvey K. St. Mary, Downey, CA (US)

Correspondence Address: AVERILL & VARN, 8244 PAINTER AVE., WHITTIER, CA, 90602, US

(21) Appl. No.: 12/537,076

(22) Filed: Aug. 6, 2009

Related U.S. Application Data
(63) Continuation-in-part of application No. 11/781,826, filed on Jul. 23, 2007, now Pat. No. 7,571,719.
Application No. 11/781,826 is a continuation-in-part of application No. 11/330,466, filed on Jan. 12, 2006, now Pat. No. 7,249,598.
(60) Provisional application No. 61/173,172, filed on Apr. 27, 2009.

(51) Int. Cl. F02B 43/00; F01M 13/00

(52) U.S. Cl. 123/3; 123/572; 123/41.86

(57) ABSTRACT

A hydrogen augmented crankcase ventilation system includes hydrogen injection to facilitate the combustion of crankcase fumes, for example blow-by, in the engine. The system preferably includes a hydrogen generation system as a hydrogen source and introduces the hydrogen into the engine through the engine's fuel injection system. A fumes hose connects the crankcase to the air intake, and a clean air hose connects a clean air source to the crankcase. An orifice or a vacuum regulator cooperates with the fumes hose and may be included to regulate crankcase vacuum. A filter resides inline with the fumes hose to capture solids or liquids which enter the fumes hose from the crankcase, and a drain hose drains captured liquid back into the engine. A back flow preventor may be included to cooperate with the clean air hose to prevent a back flow of crankcase fumes through the clean air hose.

The present application is a Continuation in Part (CIP) of U.S. patent application Ser. No. 11/781,826 filed Jul. 23, 2007 which Continuation in Part (CIP) of U.S. patent application Ser. No. 11/330,466 files Jan. 12, 2006, the present application further claims the priority of U.S. Provisional Patent Application Ser. No. 61/173,172 filed Apr. 27, 2009, which applications are incorporated in their entirety herein by reference.

### BACKGROUND OF THE INVENTION

The present invention relates to reducing emissions from diesel engines and in particular mixing hydrogen with crankcase fumes to facilitate combustion of the crankcase fumes producing useful energy.

Diesel engines are commonly used in commercial applications such as trucks and stationary engines. These engines typically have much higher compression ratios than gasoline engines, and as a result, a substantial amount of diesel blow-by escapes past the piston rings. Unlike gasoline engines which use a simple crankcase ventilation, the diesel blow-by is generally vented to the outside, and presents a source of unpleasant fumes. The diesel engines typically cannot simply vent the crankcase to the engine intake, because the diesel blow-by includes components which will degrade the diesel engine operation.

U.S. patent application Ser. No. 11/330,466 for “HYDROGEN AUGMENTED DIESEL CRANKCASE VENTILATION,” a parent of the present application, discloses a system combining hydrogen and crankcase fumes in the intake of a diesel engine, whereby the hydrogen facilitates burning the crankcase fumes to reduce emissions and to improve mileage. The system of the '466 application includes a filter 36 in the line carrying the crankcase fumes to the engine intake. In some cases, liquids included in the crankcase fumes have filled the filter and prevented optimal operation of the system. Further, many diesel engines draw air from the intake manifold which is pumped into a tank and used to actuate, for example, air brakes. Drawing hydrogen into such a system may result in undesirable conditions.

Further, difficulty has arisen in the insertion of hydrogen gas into the engine intake air stream. Such systems, known as fumigation systems, introduce gaseous hydrogen into the engine through the air intake stream. Such hydrogen fumigation systems are simple, but lack efficiency. The benefits of hydrogen fuel enhancement depend on volumetric delivery which known fumigation systems do not provide. Thus, known hydrogen fumigation systems have failed to obtain the full benefit of hydrogen fuel enhancement.

For these and other reasons, an improved hydrogen reactor and injection system for augmenting crankcase ventilation in an internal combustion engine system is needed.

### BRIEF SUMMARY OF THE INVENTION

The present invention addresses the above and other needs by providing a hydrogen augmented crankcase ventilation system which includes hydrogen injection to facilitate the combustion of crankcase fumes, for example blow-by, in the engine. The system preferably includes a hydrogen generation system as a hydrogen source and introduces the hydrogen into the engine through the engine's fuel injection system. A fumes hose connects the crankcase to the air intake, and a clean air hose connects a clean air source to the crankcase. An orifice or a vacuum regulator cooperates with the fumes hose and may be included to regulate crankcase vacuum. A filter resides inline with the fumes hose to capture solids or liquids which enter the fumes hose from the crankcase, and a drain hose drains captured liquid back into the engine. A back flow preventor may be included to cooperate with the clean air hose to prevent a back flow of crankcase fumes through the clean air hose.

In accordance with another aspect of the invention, there is provided an engine and a hydrogen augmented crankcase ventilation system. The engine includes an engine air intake, and an engine crankcase. The hydrogen augmented crankcase ventilation system includes a hydrogen source, a first hose connecting the hydrogen source to the engine fuel system, a second hose connecting the engine crankcase to an engine air intake, and third hose in fluid communication with the engine crankcase carrying a third flow of fresh air into the crankcase. The first hose carries a first flow including hydrogen from the hydrogen source to the engine fuel system to mix the hydrogen with liquid engine fuel. The second hose carries a second flow from the engine crankcase to the engine air intake, such that the second flow is mixed with air received by the diesel engine through the engine air intake.

In accordance with another aspect of the invention, hydrogen is introduced into the combustion process by utilizing the engine's already-existing fuel delivery system. By producing, collecting and mixing measured amounts of gaseous hydrogen into the fossil fuel stream, the present invention provides the proper amount of hydrogen without the need for the kinds of computer-regulated monitoring systems used by sophisticated fumigation systems.

In accordance with another aspect of the invention, the entire reactor mechanism is made out of an elastomeric material which encases the reactor cell to provide safety and durability and contains the water utilized in the hydrogen production process. Known hydrogen generators are aluminum or stainless steel and are not well-suited for the variety of operating conditions in everyday use. Failures are common when the known systems are stressed and the aluminum or stainless steel construction provides no benefit over the elastomeric material of the present invention.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a prior art diesel engine.

FIG. 2 is an improved diesel engine including a hydrogen augmented diesel crankcase ventilation system according to the present invention.

FIG. 3 is a second embodiment of an improved diesel engine including a hydrogen augmented diesel crankcase ventilation system including an improved filter according to the present invention.

FIG. 4 is a third embodiment of an improved diesel engine including a hydrogen augmented diesel crankcase ventilation system according to the present invention with different breather plumbing.

FIG. 5A is a side view of a suitable filter for filtering crankcase fumes according to the present invention.

FIG. 5B is a front view of the filter.

FIG. 5C is a top view of the filter.

FIG. 6 is a cross-sectional view of the filter taken along line 6-6 of FIG. 5C.

FIG. 7 is a diagram of a hydrogen reactor and injection system according to the present invention.

FIG. 8 is a hydrogen reactor according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Hereafter, the term “gases” refers to “hydrogen” in reference to a gasoline internal combustion engine and a mixture of “hydrogen and oxygen” in a diesel internal combustion engine, the difference being that efficiency calls for the presence of oxygen in a diesel engine and the absence of oxygen in a gasoline engine during combustion.

A process of electrolysis of water (H₂O) results in the decomposition of a water-based solution into oxygen (O₂) and hydrogen (H₂) gases. Electric power is connected to electrodes comprising anodes and cathodes. Hydrogen will appear at the cathode(s) (the negatively charged electrode), and oxygen will appear at the anode (the positively charged electrode). The chemical reaction is:

2H₂O [symbol] 2H₂+O₂

thus, the number of hydrogen molecules generated is twice the number of oxygen molecules generated, and the rate of production of the gasses is proportional to the total electrical charge that was sent through the water.

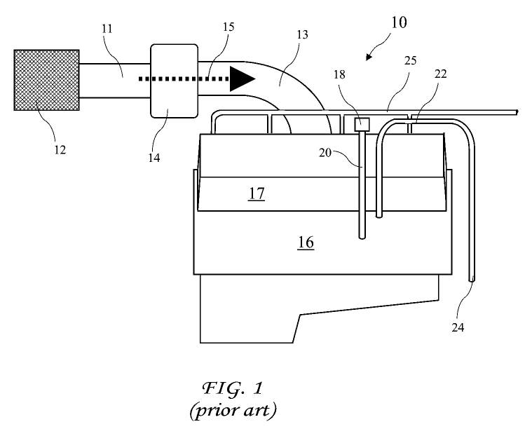

A known diesel cycle engine 10 is shown in FIG. 1. Diesel cycle engines generally use common diesel fuel, but may use other fuels, for example, biodiesel fuel, or the like. The diesel engine 10 includes an engine block 16 which encloses a crankcase. One or two cylinder heads 17 are attached to the block 16 and generally contain valves and intake and exhaust ports. An air flow 15 used in the combustion process enters the diesel cycle engine 10 through an air cleaner 12, passing through an air intake 11 and a super charger 14, which supercharger 14 is preferably a turbo supercharger (or turbocharger), and through an intake manifold 13 (which may include any ducting between the supercharger 14 and the engine 10) and into the engine 10. Liquid fuel is provided to the engine 10 through a fuel line 25. The known diesel cycle engine 10 further includes an oil fill cap 18 on an oil fill tube 20 for adding motor oil to the diesel cycle engine 10. The diesel cycle engine 10 also includes a crankcase breather 22 with an open end 24 for venting the crankcase and allowing diesel blow-by and the like to escape the crankcase.

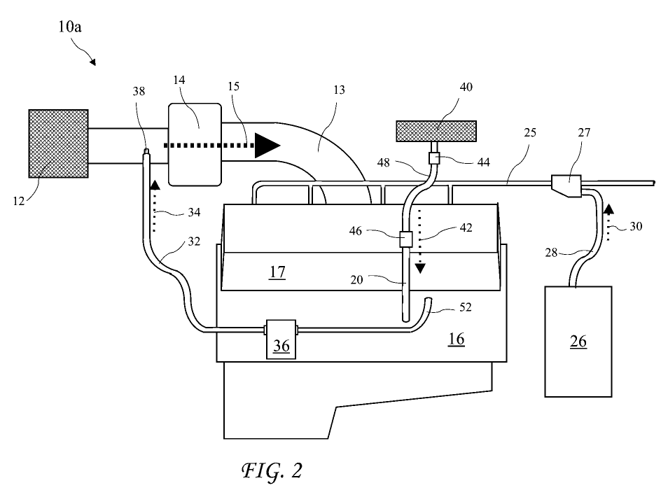

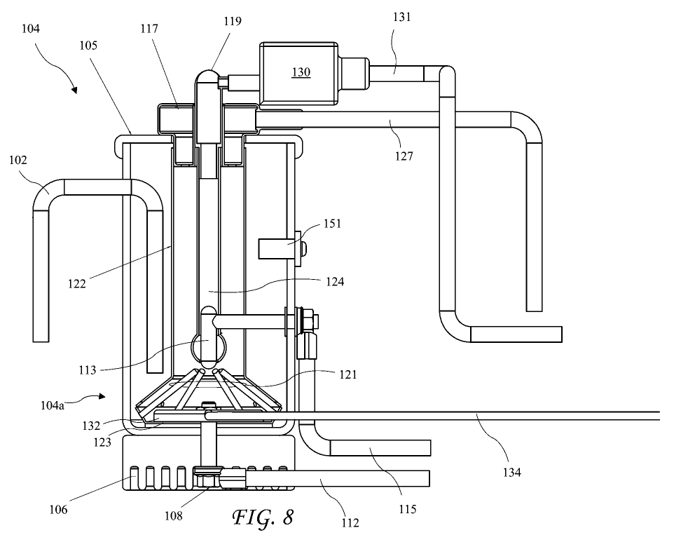

An improved diesel cycle engine 10a with a hydrogen augmented diesel crankcase ventilation system according to the present invention is shown in FIG. 2. The diesel cycle engine 10a includes a hydrogen source 26 which is preferably a hydrogen generator. Examples of known hydrogen generators are described in US Patent Application Publication No. 2005/0258049 for “Hydrogen Generator For Use in a Vehicle Fuel System,” U.S. Pat. No. 4,573,435 for “Method and Apparatus for Generating Hydrogen Gas for Use As a Fuel Additive on a Diesel Engine,” U.S. Pat. No. 6,155,212 for “Method and Apparatus for Operation of Combustion Engines,” and U.S. Pat. No. 6,901,889 for “Fumigation System for a Diesel Engine”. The '049 application and the '435, '212, and '889 patents are herein incorporated by reference. An example of a suitable hydrogen generator is a Hydrogen Fuel Injection™ (HFI) system built by Canadian Hydrogen Energy Company Ltd, in Ontario, Canada. A preferred hydrogen generation and injection system is described in U.S. Provisional Patent Application Ser. No. 61/173,172 filed Apr. 27, 2009 and in FIGS. 7 and 8 below.

The hydrogen source 26 is connected to the fuel line 25 by a hydrogen hose 28 at a Y block 27. A hydrogen flow 30 including hydrogen gas is carried by the hydrogen hose 28 from the hydrogen source 26 to the fuel line 25. The hydrogen flow 30 may consist essentially of hydrogen gas produced by a hydrogen generator from water, or consist essentially of a combination of both hydrogen gas and oxygen gas produced by the hydrogen generator from water.

In another embodiment, a separate oxygen hose may carry the oxygen gas to the fuel line 25.

The breather 22 (see FIG. 1) is replaced by a breather hose 52, first filter 36, and fumes hose 32 connecting the crankcase to the air intake 11. The filter 36 is connected in-line with the fumes hose 32, wherein the filter 36 may be at either end of the fumes hose 36, or reside along the fumes hose 36. The hose 52 preferably connects to the block 16 where the breather 22 (see FIG. 1) would otherwise connect and the filter 36 catches any solids or liquids which enter the hose 52. The filter 36 may further include a clear body to allow observation of any solids or liquids collected by the filter 36.

The air intake 11 may provide the air flow 15 to the diesel cycle engine through a supercharger 14, or directly to the intake manifold 13 or to the diesel cycle engine 10a. A supercharge generally provides greater vacuum in the fumes hose 32, but in many cases, the intake manifold vacuum in a normally aspirated (i.e., non-supercharged) engine is sufficient. Preferably, the supercharger 14 is a turbo supercharger (or turbocharger). Further, the engine 10a may include two or more superchargers, one or more of which may be turbo superchargers.

The hoses 52 and 32 carry the fumes flow 34 comprising blow-by and other crankcase fumes (e.g., fumes generated by the breakdown of engine oil) and material which previously was vented to the atmosphere through the breather 22 (see FIG. 1).

A restriction 38 restricts the fumes flow 34, which restriction 38 preferably cooperates with the hose 32 or the hose 52, and more preferably resides proximal to the connection point of the hose 32 to the air intake 11. The restriction 38 regulates (or limits) the fumes flow 34 into the air intake 11. The restriction 38 may be manually adjustable or may be self adjusting, for example, like a pressure or vacuum regulator, or may, for example, be a fixed size replaceable orifice, a variable orifice, or a clamp to squeeze the outside of the hose 32 or the hose 52 to restrict the fumes flow 34. The restriction 38 may be used to adjust crankcase vacuum and preferably results in between approximately one pound and approximately four pounds of crankcase vacuum, and more preferably results in approximately two pounds of crankcase vacuum. In general, a larger engine will operate with a higher crankcase vacuum, and a small engine will operate with a lower crankcase vacuum. The restriction 38 may further cooperate with a vacuum regulator in the clean air hose 48 to regulate crankcase vacuum.

A second air filter 40 may for convenience be connected to the oil fill tube 20 by a clean air hose 48 and a coupling 46 to provide clean air to the crankcase, but may be connected to the crankcase through any appropriate passage. The air filter 40 allows a clean air flow 42 of clean air to enter the crankcase to support a flow through the crank case and into the hose 32, and/or to help cool the crankcase. A back flow preventor 44 may reside inline in the clean air hose 48 to prevent blow-by or other fumes, liquids, or solids from escaping the diesel cycle engine 10a through the air filter 40. The back flow preventor 44 may further include a vacuum regulator to regulate the crankcase vacuum. The crankcase vacuum is preferably regulated to be between approximately one and approximately four pounds.

While hoses 28, 32, 48, and 52 are referenced above, metal or plastic tubing may be used as well, or any suitable conduit, may be used to carry the flows 30, 34, and 42. Also, the hose 52 and the hose 48 may connect with the crankcase at any suitable point using any suitable connection, and are not limited to connecting through existing connection points.

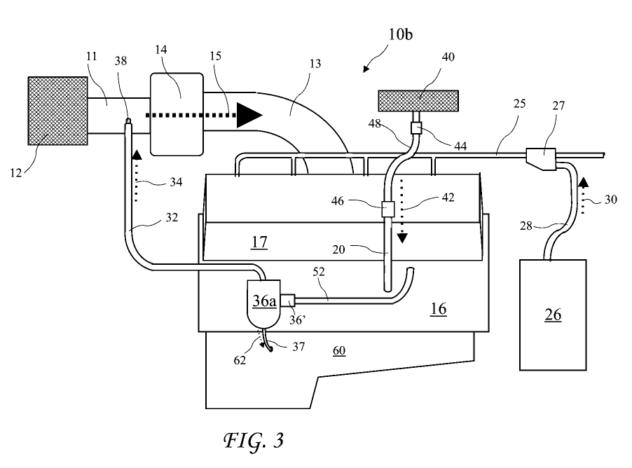

A second embodiment of an improved diesel engine 10b including a hydrogen augmented diesel crankcase ventilation system according to the present invention is shown in FIG. 3. The engine 10b includes a second filter 36a which collects liquid in the fumes flow 34 and returns the liquid to the crankcase (or oil pan) as a liquid flow 62 through a drain line 37. In some instances, fluids may accumulate in the filter 36 at a high rate. Such high rate may fill the first filter 36 (see FIG. 2) during a single trip, and may reduce the performance of the present invention. In these applications, the filter 36a with the filter drain line 37 may be included to carry fluids trapped by the filter 36a to the oil pan 60. The filter drain line 37 may attach at a dedicated attachment point, or connect to the filler tube 20, or any tube running to the oil pan or to the crankcase allowing a gravity flow from the filter 36. The drain line 37 may connect to the oil fill tube 20 or be independently plumbed into the engine block 16 or the oil pan 60 depending on the relative heights of the filter 36 and lowest point of the oil fill tube 20. The filter 36a may further include a clear body to allow observation of any solids or liquids collected by the filter 36a, and may further include a back flow preventor 36′, for example, residing where the hose 52 is attached to the filter 36a. The engine 10b is otherwise similar to the engine 10a.

A third embodiment of an improved diesel engine 10c including a hydrogen augmented diesel crankcase ventilation system according to the present invention is shown in FIG. 4. The improved diesel engine 10c includes a “T” 50 connecting a first breather hose 52a to a second breather hose 52b and to the clean air hose 48. The improved diesel engine 10c is otherwise similar to the improved diesel engine 10a.

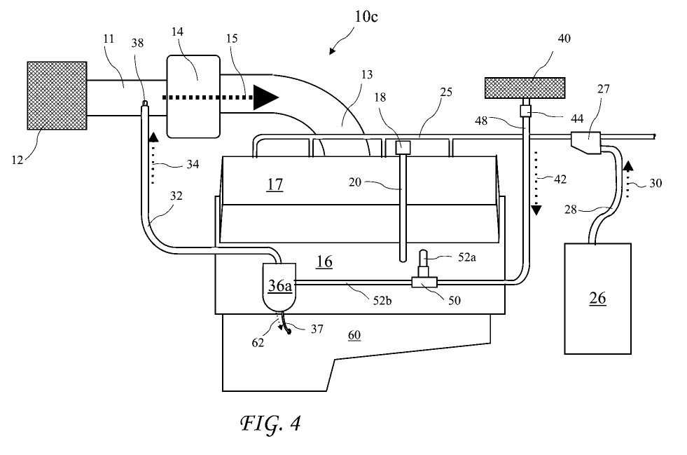

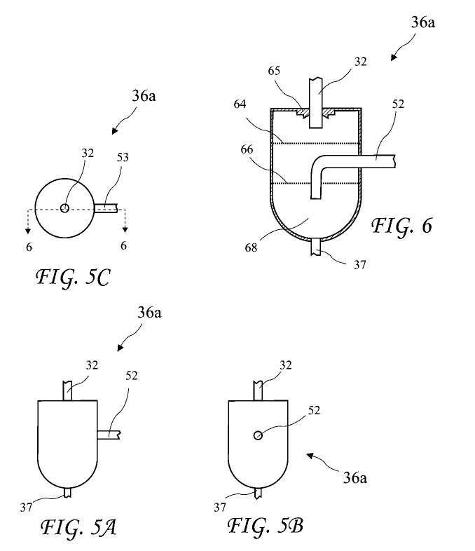

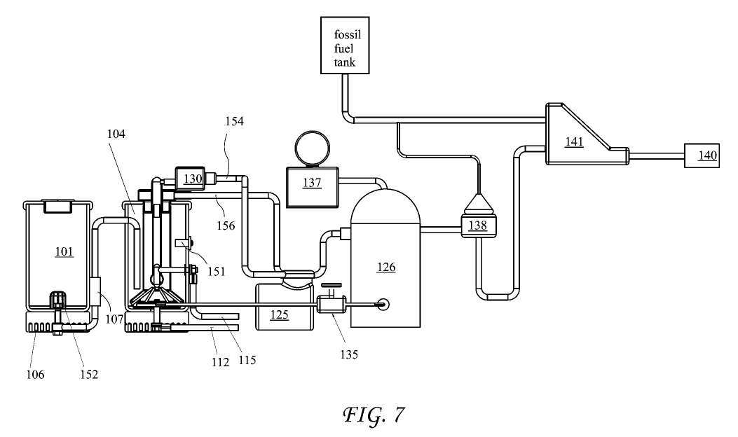

A side view of an example of a suitable filter 36a according to the present invention is shown in FIG. 5A, a front view of the filter 36a is shown in FIG. 5B, and a top view of the filter 36a is shown in FIG. 5C. A cross-sectional view of the filter 36 taken along line 6-6 of FIG. 5C is shown in FIG. 6. The filter 36a includes an upper screen 64 and a lower screen 66. The hose 52 enters the filter 36a and turns down terminating below the lower screen 66. The hose 32 enters the top of the filter 36a and terminates above the upper screen 64. A bowl 68 is formed in the bottom of the filter 36a to catch liquids and to direct the liquids to the hose 37 at the lowest point of the bowl 68. A barrier 65 is formed around the exit point of the hose 32 from the filter 36a to facilitate liquids forming drops and falling into the bowl 68. The filter 36a thus catches liquids in the fume flow 34 to return the liquids to the crankcase.

A diagram of a hydrogen reactor and injection system according to the present invention is shown in FIG. 7. A power source provides electrical power to a hydrogen reactor 104. The power source may be a battery, an alternator, or a generator carried by a vehicle, but is preferably a large battery to provide constant production of hydrogen regardless of fluctuation in engine speed. The reactor 104 produces hydrogen and oxygen by the electrolysis of water as described above. A vehicle may have a single reactor 104 producing hydrogen, or several reactors 4 producing hydrogen where needed.

A reserve tank 101 provides water to the reactor 104 through a reserve tank pump 107 controlled by a proximity switch 151 mounted to the side of the reactor 104. When the water level in the reactor 104 drops below the proximity switch 151, the reserve tank pump 107 is turned on to resupply the reactor 104 with water. The reserve tank includes a heat sink 6 at the base of the tank and a filter 152 preventing debris from escaping the reserve tank into the reactor 4.

A flow of gas from the reactor 104 passes through a first check valve 130 to a compressor 125. If the compressor 125 were to exceed a safe temperature and reach a flash point, an explosion could result. The check valve 30 protects against flames in the compressor 125 entering the reactor 104. The compressed gas from the compressor 125 enters a hydrogen storage tank 126. The compressor 125 is preferably constructed from non-metallic material to prevent electrolysis in the compressor 125.

A high pressure regulator 137 monitors the pressure level in the hydrogen storage tank 126. When the pressure exceeds an upper limit, the high pressure regulator 137 switches the compressor 125 off. When the pressure drops below a lower limit, the high pressure regulator 137 switches the compressor 125 on.

The high pressure gasses from the hydrogen storage tank 126 pass through a linear regulator 138 and into a Y block 136. The linear regulator 138 includes a reference port connected to the fossil fuel supply which adjusts the pressure of the gasses continuously to be equal to, or slightly above, the pressure of the fossil fuel supply to facilitate and regulate mixing in the Y block 136. The exact setting of the linear regulator 138 generally will be tuned to a specific application, or preset to a target application.

The fossil fuel flow from a fossil fuel tank flows through a fuel pump and also into the Y block 141. The gasses and the fossil fuel are mixed in the Y block 141 and proceed through an atomizer 140 which atomizes and mixes the hydrogen and fossil fuel in the fuel stream before injection through fuel injectors for combustion in the engine.

A line from the hydrogen storage tank 126 also flows through a scrubber control valve 35 and a hydrogen scrubber tube 134 (see FIG. 8) to a scrubber manifold in the base of the reactor 104. Hydrogen gas from the scrubber manifold rises past the cathode elements 21 to free hydrogen bubbles on the cathode elements.

Typically, modern engines include a bypass fuel system, and fossil fuel not required by the engine is returned to the fossil fuel tank. In the instance of the present system, the returned fossil fuel and hydrogen mixture is separated in a hydrogen/fossil fuel separator and the fossil fuel is returned to the fossil fuel tank and the hydrogen (along with aldehydes, esters and other fuel fumes) is returned to the reactor 104.

A detailed view of the reactor 104 according to the present invention is shown in FIG. 8. The base 104a of the reactor 104 includes a family of cathodes 121 surrounding an anode 113. The hydrogen and oxygen gases produced by the electrolysis occurring in the reactor 104 are separately gathered by an oxygen tube 124 above the anode 113 and a hydrogen chamber 122 above the cathodes 121 and surrounding the oxygen tube 124. The oxygen gasses are collected in an oxygen cap 119 at the top of the reactor 104, and hydrogen gasses are collected in a hydrogen cover 117 on the top of the reactor.

The hydrogen and oxygen gases are drawn from the oxygen cap 19 and the hydrogen cover 117 and compressed by the compressor 125 and stored in the hydrogen storage tank 126. The oxygen gasses flow through the oxygen regulator and check valve 130 and may be limited or prevented from flowing further in the system depending on the application. The unused oxygen is expelled through an exhaust line or vent on the check valve 30.

The reactor 104 is made from high-impact elastomeric materials that are impervious to the kinds of high acid or alkali conditions result from the chemical reactions that occur during electrolysis of dissimilar metals in high PH solutions. The reactor 104 is made to withstand erosion factors from its own cross-sectional strength, and to resist ozone and stress produced by varying environmental (e.g, temperature and moisture) and operating conditions (driving on rough roads, braking, and turning). The elastomeric materials must be resilient such that they cannot distort and will remain inflexible during fully encumbered periods (i.e., ultra-high pressure of compressed gasses in small spaces). The reactor core base is also elastomeric so that any sudden impact can be directed to open the incoming electrical circuit and shut down the transmission of electricity. Using low durometer elastomeric materials also dampens the effects of road and engine vibrations. An example of a suitable elastomeric material is vulcanized rubber.

The cathodes 121 are preferably thoriated tungsten (or similar material) and are arranged in a circle or ellipse at specific angles tangent with a lowest point of the anode 113. The reactor anode 113 and cathode 121 components are partially encased by the elastomeric material along with their respective connections 115 and 113 to the power source. The anode 113 and cathodes 121 are held in specific geometric positions within the cast material in order to insure correct alignment and location of each component.

The base 104a includes a reactor heat sink 106 with exposed downward pointing fins. A reactor insulator 123 resides under the cathodes 121 and a scrubber manifold 132 also resides under the cathodes 121 and is connected to the hydrogen scrubber tube 134 to receive a flow of hydrogen gas. A fill tube 102 receives water from the reserve tank 101. The foundation of the reactor 104 is preferably parabolic and supports the reactor cells. In the event of an impact from outside the reactor 104, the parabola design causes the circuits connecting and powering the anode and cathode components of effected reactor cells to open and directs all fluids in the reactor base 104a up into the plenum chamber 118 to prevent any possibility of a fire or explosion.

Each reactor 104 is designed to keep the cathodes 121 and anode 13 submerged in the electrolytic solution at all times. By remaining submerged, the reactor components are not exposed to oxidation or erosion in the atmosphere, which can significantly reduce efficiency. Also, by keeping the cathodes 114 and anode 116 submerged in the electrolytic solution, the reactor's operating temperature remains stable and therefore improves durability and prolongs the reactor's life. All reactor core components which transfer or provide power to the core are encapsulated or covered. Only the hydrogen-producing surfaces of the cathodes 121 and anode 113 are exposed to the electrolytic solution. The configuration of the reactor 104 described above reduces energy requirements and minimizes loss of energy.

While the most common application of the hydrogen reactor and injection system according to the present invention is to diesel and gasoline powered vehicles, the present invention is equally advantageous when applied to generators, industrial engines, stationary engines or any internal combustion engine.

While the invention herein disclosed has been described by means of specific embodiments and applications thereof, numerous modifications and variations could be made thereto by those skilled in the art without departing from the scope of the invention set forth in the claims.

I claim:

1. A hydrogen augmented crankcase ventilation system comprising:
an engine including:
an engine air intake;
an engine crankcase; and
the hydrogen augmented crankcase ventilation system comprising:
a hydrogen source;
a first hose connecting the hydrogen source to the engine fuel system, the first hose carrying a first flow including hydrogen from the hydrogen source to the engine fuel system to mix the hydrogen with liquid engine fuel;
a second hose connecting the engine crankcase to an engine air intake, the second hose carrying a second flow from the engine crankcase to the engine air intake, such that the second flow is combined with air received by the diesel engine through the engine air intake; and
a third hose in fluid communication with the engine crankcase, the third hose carrying a third flow of fresh air into the engine crankcase.

2. The system of claim 1, wherein the hydrogen source is a hydrogen generator and the first hose carries hydrogen gas to the engine fuel system.

3. The system of claim 1, wherein the engine air intake resides between an air cleaner and a super charger.

4. The system of claim 3, wherein the engine air intake resides between an air cleaner and a turbocharger.

5. The system of claim 1, wherein the third hose is connected between a second air cleaner and the crankcase.

6. The system of claim 5, wherein the third hose includes an in-line back flow preventor.

7. The system of claim 5, wherein the third hose connects to the crankcase through an oil fill tube.

8. The system of claim 5, wherein the third hose includes a vacuum regulator.

9. The system of claim 5, wherein the second air filter includes an in-line back flow preventor.

10. The system of claim 1, wherein the second hose includes an inline filter for collecting liquids which enter the second hose.

11. The system of claim 1, wherein the in-line filter includes a clear portion for viewing liquids collected by the in-line filter.

12. The system of claim 1, wherein the in-line filter is connected to a drain line for draining liquids caught by the on-line filter to the engine.

13. The system of claim 1, wherein the second flow is restricted to limit the amount of flow.

14. The system of claim 13, wherein the second flow is restricted to result in a crankcase vacuum between approximately one pound and approximately four pounds.

15. The system of claim 1, further including an orifice for regulating the second flow through the second hose from the crankcase to the air intake.

16. The system of claim 15, wherein the orifice resides proximal to where the second hose connects to the air intake.

17. The system of claim 1, wherein the hydrogen is provided by a hydrogen reactor, the hydrogen reactor comprising:
a housing;
a base portion containing active elements for producing the hydrogen;
a cathode centered in the base of the housing
a multiplicity of anodes in the base of the housing surrounding the cathode;
a top portion containing a plenum chamber;
a fill passage extending from above the housing to add an electrolyte;
a pump for drawing and compressing hydrogen produced by the hydrogen reactor
a high pressure tank for holding the compressed hydrogen;
a hydrogen pressure regulator referenced to a liquid fuel pressure and regulating a flow of compressed hydrogen from the high pressure tank;
a Y block for mixing the pressure regulated hydrogen with the liquid fuel; and
a fuel injection system for injecting the hydrogen and liquid fuel mixture into the engine.

18. A diesel cycle engine including a hydrogen augmented crankcase ventilation system, the engine comprising:
a diesel cycle engine including:
an engine air intake residing between an air cleaner and a super charger; and
an engine crankcase containing at least one of a set of crankcase fumes consisting of blow-by and fumes resulting from the breakdown of engine oil;
a hydrogen generator which generates hydrogen gas;
a first hose connecting the hydrogen generator to an engine fuel line which first hose carries a first flow of hydrogen from the hydrogen generator to the engine fuel line;
a second hose connecting the engine crankcase to the engine air intake, which second hose carries a second flow of crankcase fumes from the crankcase to the engine air intake, such that the second flow is combined with air received by the diesel cycle engine through the engine air intake;
a third hose connecting a second air cleaner to the engine crankcase to provide a third flow of fresh air to the crankcase; and
a restriction cooperating with the second flow.

19. The system of claim 18, wherein the third hose includes a vacuum regulator.

20. A hydrogen augmented diesel cycle engine crankcase ventilation system comprising:
a diesel engine including an engine air intake residing between an air cleaner and a super charger;
a hydrogen reactor for producing hydrogen, the hydrogen reactor comprising:
a housing;
a base portion containing active elements for producing the hydrogen;
a cathode centered in the base of the housing a multiplicity of anodes in the base of the housing surrounding the cathode;
a top portion containing a plenum chamber;
a fill passage extending from above the housing to add an electrolyte;
a pump for drawing and compressing hydrogen produced by the hydrogen reactor
a high pressure tank for holding the compressed hydrogen; and
a hydrogen pressure regulator referenced to a liquid fuel pressure and regulating a flow of compressed hydrogen from the high pressure tank;
a Y block for mixing the pressure regulated hydrogen with the liquid fuel;
a fuel injection system for injecting the hydrogen and liquid fuel mixture into the engine;
a second hose connecting an engine crankcase to the engine air intake to carry a second flow of crankcase fumes from the engine crankcase to the engine air intake, such that the first and second flows are combined together and joined with air received by the diesel engine through the engine air intake;
a restriction cooperating with the second flow to restrict the second flow;
a third hose connecting a fresh air source to the engine crankcase to carry fresh air to the engine crankcase; and
a back flow preventor cooperating with the third hose to prevent a back flow through the third hose.
